(19) United States
(12) Patent Application Publication
(10) Pub. No.: US 2007/0217044 A1
(43) Pub. Date: Sep. 20, 2007

(54) BACK UP SAFETY MIRROR

(76) Inventor: Glenn Harewood, Brampton (CA)

Correspondence Address: Dennison Associates, Suite 301, 133 Richmond Street West, Toronto, ON, M5H 2L7, CA

(21) Appl. No.: 11/425,337

(22) Filed: Jun. 20, 2006

Related U.S. Application Data
(60) Provisional application No. 60/691,875, filed on Jun. 20, 2005.

(51) Int. Cl. G02B 7/182

(52) U.S. Cl. 359/871

(57) ABSTRACT

A safety mirror for mounting at the rear of a vehicle to allow an operator of the vehicle to observe images of objects which may be present to either side of the rear of the vehicle, the safety mirror comprising a convex reflective mirror surface for mounting at the rear of the vehicle such that images of objects to either side of the rear of the vehicle are reflected in the safety mirror toward the front of the vehicle.

### FIELD OF THE INVENTION

The present invention is directed to a back up safety mirror which allows a driver to observe both sides of a vehicle and to the rear of the vehicle as they are backing up the vehicle.

### BACKGROUND OF THE INVENTION

Sports utility vehicles (SUVs) and minivans which tend to be higher and longer than sedans and coupe type cars are becoming very prevalent. It can be difficult for a driver of a regular vehicle parked between such SUVs or minivans to be able to see beyond these vehicles to determine whether it is safe to back out, particularly, when backing out of a parking spot in a parking lot. Generally, in these situations, the driver will cautiously inch out of the parking spot hoping that no one is coming down along the aisle behind the parking spot until they can safely see around the vehicles to either side of the vehicle. The driver may sound the horn, but there is no guarantee that a driver of an approaching vehicle is going to be paying attention to the sound of the horn.

There thus remains a need for a safety mirror which would allow a driver to see to either side and to the rear of a vehicle to safely back out of a parking spot.

### SUMMARY OF THE INVENTION

The present invention is directed to a safety mirror made from a reflective magnifying glass suspended at a convenient location on the rear bumper or corner of a vehicle on a driver's side of the vehicle. The mirror reflects any object that is approaching the rear of the vehicle from either side of the vehicle.

In one aspect the present invention provides a safety mirror for mounting at the rear of a vehicle to allow an operator of the vehicle to observe images of objects which may be present to either side of the rear of the vehicle. The safety mirror comprises a convex reflective mirror surface for mounting at the rear of the vehicle such that images of objects to either side of the rear of the vehicle are reflected in the safety mirror toward the front of the vehicle.

In another aspect of the invention the safety mirror is attached to a support arm for attachment to a rear bumper of a vehicle.

In a further aspect of the invention the attachment of the mirror to the support arm is a pivotable attachment to allow the position of the safety mirror to be adjusted for optional viewing of the images of objects.

Yet another aspect of the invention provides a motor vehicle having an operator position and an operator mirror mounted to a side of the vehicle to allow an operator to observe images of objects to the rear of the vehicle reflected in the operator mirror. The vehicle has a safety mirror attached to a rear corner of the vehicle, the image of the safety mirror being observable in the operator mirror. The safety mirror comprises a convex reflective mirror surface for mounting at the rear of the vehicle such that images of objects to either side of the rear of the vehicle are reflected in the safety mirror toward the operator mirror to be observed by the operator in the operator mirror.

### BRIEF DESCRIPTION OF THE DRAWINGS

Preferred embodiments of the present invention are illustrated in the attached drawings in which:

FIG. 1 is a schematic view illustrating the operation of the safety mirror of the present invention.

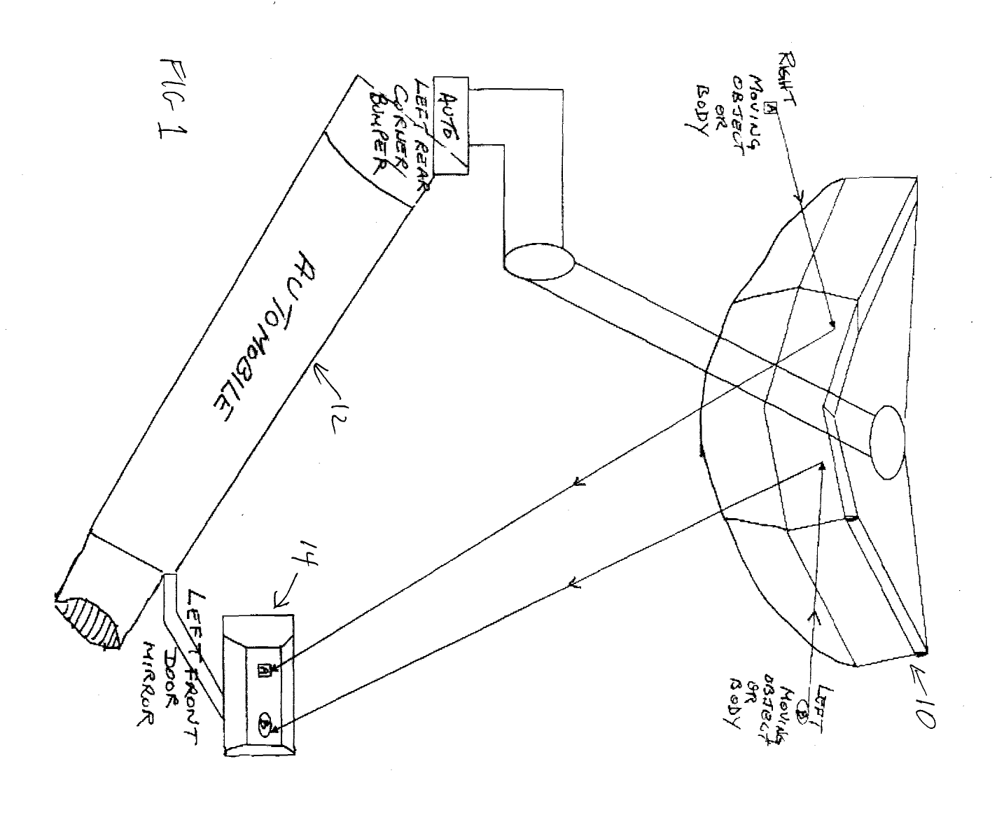

### DETAILED DESCRIPTION OF THE PREFERRED EMBODIMENTS

A preferred embodiment of a safety mirror of the present invention is illustrated in the figures generally indicated by the numeral 10. The safety mirror 10 is attached to the rear of a vehicle 12 such that the safety mirror is behind the vehicle 12 and visible in the driver's door mirror 14 of the vehicle 12. Preferably, the safety mirror 10 will be suspended 6 to 8 inches above the rear bumper 16 at a 45 to 60 degree angle so that the mirror 10 projects outwardly and backwardly from the left rear corner of the vehicle 12. As illustrated in the figures, the mirror 10 is convex in shape such that any vehicular or other movement approaching from the left or the right of the vehicle 12 is reflected by the safety mirror 10 onto the standard outside mirror 14 of the driver's door and thus visible to a driver operating the vehicle 12. This allows the driver to see if there any objects approaching the rear of the vehicle 12 and allow them to back out safely from between larger vehicles or other objects that may be parked on the sides of the driver's vehicle 12 or that create a blind spot that blocks the driver's view and impairs the trial and error blind spot of backing out.

The convex safety mirror 10 of the present invention is made of a reflective magnifying glass, is portable and can easily and firmly be attached to the rear corner of the vehicle 12. It is suspended on a sturdy stand 20 on which it is mounted so that it may be pivoted into the proper position such that it reflects objects approaching from either side of the rear of the vehicle 12 into the mirror 14 on the driver's door of the vehicle. The mirror 10 should be mounted such that it will not be a safety hazard and is able to withstand all types of weather conditions and is relatively inexpensive to produce.

While the preferred embodiment describes a convex mirror, other shapes of the mirror are possible provided they reflect the approaching vehicles from either side of the parked vehicle. Thus for example, the mirror may be cylinder shaped, cone shaped or any other shape that allows for the proper reflection.

The safety mirror of the present invention is also adaptable for mounting on SUVs, minivans and other vehicles where the roof line extends to the rear of the vehicle. In these situations, the mirror in addition to being mounted on the bumper, may also be mounted at the top rear corner of the vehicle on the driver's side so that the reflection of the approaching vehicles will be visible.

Although various preferred embodiments of the present invention have been described herein in detail, it would be appreciated by those skilled in the art that variations may be made thereto without departing from the spirit of the invention or the scope of the appended claims.

1. A safety mirror for mounting at the rear of a vehicle to allow an operator of the vehicle to observe images of objects which may be present to either side of the rear of the vehicle, the safety mirror comprising a convex reflective mirror surface for mounting at the rear of the vehicle such that images of objects to either side of the rear of the vehicle are reflected in the safety mirror toward the front of the vehicle.

2. A safety mirror according to claim 1 wherein the mirror is attached to a support arm for attachment to a rear bumper of a vehicle.

3. A safety mirror according to claim 2 wherein the attachment of the mirror to the support arm is a pivotable attachment to allow the position of the safety mirror to be adjusted for optional viewing of the images of objects.

4. A motor vehicle having an operator position and an operator mirror mounted to a side of the vehicle to allow an operator to observe images of objects to the rear of the vehicle reflected in the operator mirror, the vehicle having a safety mirror attached to a rear corner of the vehicle, the image of the safety mirror being observable in the operator mirror, the safety mirror comprising a convex reflective mirror surface for mounting at the rear of the vehicle such that images of objects to either side of the rear of the vehicle are reflected in the safety mirror toward the operator mirror to be observed by the operator in the operator mirror.
